(19) United States
(12) Patent Application Publication
(10) Pub. No.: US 2008/0246864 A1
(43) Pub. Date: Oct. 9, 2008

(54) Electronic Imaging Carousel

(76) Inventor: Andrew Jon Selin, Cambridge, MN (US)

Correspondence Address: Andrew Selin, 34175 Verdin St. NW, Cambridge, MN, 55008, US

(21) Appl. No.: 11/697,728

(22) Filed: Apr. 7, 2007

(51) Int. Cl. H04N 5/335

(52) U.S. Cl. 348/294; 348/340; 348/E05.091

(57) ABSTRACT

An electronic motion picture camera apparatus has more than one imaging sensor arranged around a central axis. Image sensors are exposed individually at a single optical gate by being physically rotated into position. The optical gate is covered during the arrangement's rotation by a coordinated rolling shutter. Image information is transmitted from the rotating arrangement to a stationary receiver. The ability to use multiple and separate sensors allows the usage of higher quality image sensors even when such sensors are not normally conducive to video applications.

### CROSS REFERENCE

### US Patent Documents

| | | |
|---|---|---|
| 2,052,960 | January 1936 | Berggen |
| 5,513,202 | May 1996 | Kobayashi |
| 6,175,142 | January 2001 | Toshihiro |
| 4,695,887 | September 1987 | Peterson |
| 4,962,495 | March 1998 | Gibbons |

### BACKGROUND OF THE INVENTION

The invention seeks to improve on the prior art of motion picture camera image acquisition. The prior art of motion picture camera imaging made use of a chemical medium that reacts to visible light. The medium is presented in a selective fashion by means of transporting a length of the medium in front of an optical assembly selectively. The medium is presented such that chemical reactions to light are captured. This medium can then subsequently put through another chemical process, typically at an established facility for doing so, whereby the visual data collected can be observed both with the unaided human eye and with the use of a projector. The film medium at this stage has been “developed”.

In recent years, for the purposes of reproduction, requirements to include computer generated imagery, as well as other factors, has increased the demand for digitizing film. Digitizing takes the visual data collected from film stock and translates the visual data into electronically readable sequences of 0s and 1s whereby the data can translate to and interpret from other media.

Due both to the expense of film stock, its lack of reusability, as well as the flexibility of reviewing collected visual data electronically without the need for further development, electronic motion picture cameras have gained popularity.

Electronic motion picture cameras or video cameras use a variety of means to electronically measure light or light wavelengths at distinct points from an optical assembly. The devices that collect or translate visible light into measurable electrical energy are commonly referred to as image sensors. Electric or physicochemical sensors that fulfill this description are applicable to this apparatus.

This invention seeks to marry the prior art of film-based image acquisition with electronic imaging. While numerous devices exist for acquiring optical image information electronically, the platforms are limited both in quality and speed by the image sensors used. While image sensors exist that are individually capable of capturing multiple frames per second, the speed of the sensors is reached by degrading image resolution. A majority of these systems are limited to single image sensors, the remainder using multiple sensors to handle respective light spectrums. Instead of utilizing image sensor technology to provide video data, the invention specifies the use of separate image sensors or sensor arrays each provided sequentially to an optical assembly. By providing a platform by which a number of sensors can be used alternately, the speed of the image sensor's processing can be mitigated, resulting in the retention of higher quality image information. This invention seeks to obtain a high degree of image quality while providing appreciably rapid frame rates. The only limitations to such a platform would be the number and type of sensors employed and the speed of image data transmission and means of information storage.

### SUMMARY OF THE INVENTION

The operation of motion picture cameras is well known. The object of the invention is to meet the same intents as a motion picture camera of the prior art, utilizing many of the prior art's embodiments while providing different means with respect to the acquisition and issuing of collected image data.

As with the prior art, the invention requires a light-tight enclosure, an optical opening in that enclosure selectively masked by means of a rolling shutter, and an optical assembly fixed outside the enclosure at the opening for the purpose of focusing the light on the medium contained within the enclosure. In the prior art, the medium consisted of film emulsion arranged on spools driven by mechanical means to the opening for selective optical presentation. The object of the invention replaces the chemical medium with a plurality of electronic image sensors or sensor arrays. However unlike current video cameras, but more like the prior art, the arrangement of the image sensors is translated in position and orientation in relationship to a single optical assembly by mechanical means.

The invention consists of the arrangement of a plurality of imaging sensors or sensor arrays on respective planes tangential to a central axis. This arrangement of sensors rotates in order to present each image sensor selectively to a single optical assembly, typically a lens. The invention is an improvement to existing film cameras by providing picture acquisition without the expense of chemical film medium and with the immediacy of reviewing actual image data electronically.

The use of a plurality of image sensors or sensor arrays physically transported to and from a single optical opening in a cyclical fashion differentiates the invention from current electronic imaging cameras that make use of one or more imaging sensors situated in fixed positions from an optical assembly. Electronic imaging cameras that make use of rotational movement typically only do so to allow movement to accommodate image stabilization, and do not complete full revolutions.

The invention is an improvement to existing electronic motion picture cameras by capturing image data in a way that minimizes the impact of high contrast and high energy visuals on image sensors resulting in a closer match to current chemical-based film lighting procedures and practice. In addition the invention provides a platform wherein image quality and frame rate is only limited to the number of sensors in the system and the means of issuing image information.

### BRIEF DESCRIPTION OF THE SEVERAL VIEWS OF THE DRAWING

FIG. 1: Arrangement of sensor planes on a transverse axis with respect to an optical assembly

FIG. 2: Arrangement of sensor planes on a longitudinal axis with respect to an optical assembly

FIG. 3: Arrangement of sensor planes about a median axis with respect to an optical assembly

### DETAILED DESCRIPTION OF THE INVENTION

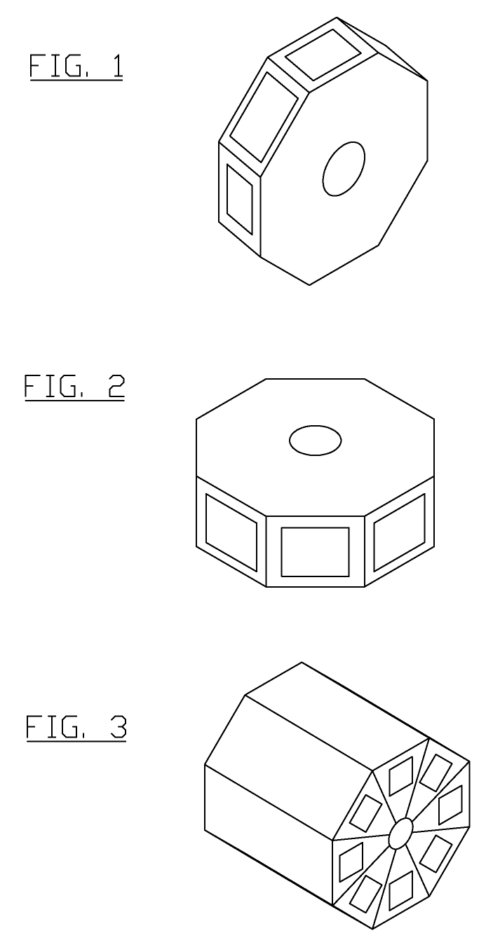

The ideal embodiment of the electronic imaging carousel comprises eight image sensor assemblies arranged about a center axis. Each sensor assembly provides a plane to which an imaging device is fixed. The plane is held tangential to the center of radial assembly by supports attached about the axis of rotation. The shaft fitted to the carousel or upon which the carousel rests has separate surfaces laminated to each side such that the electrical contact can be made whereby an electrical circuit may be completed. Electrical current is continued to each assembly by spring-loaded brushes affixed aside the arm mounts forced into contact with the respective sides of the electrical conduit through or about the axis. The sum of the assemblies is rotated about the axis transversely (FIG. 1) by constant or variable motor means. The motor's effect upon the assembly is moderated by gear or gear transmission. An initial partial gear has a plurality of teeth but only on a portion of the perimeter; this gear is fixed at the end of the motor drive. The portion of the gear having teeth engages a complete gear fixed about the axis of the carousel and fixed to the carousel. Coupled alongside this gear is a notched cylinder having semi-circle portions removed from its perimeter. Corresponding to this is a cam fixed alongside the partial gear mounted on the motor drive axle. This is arranged such that the revolution of the drive axle engages the geared portion affixed to the carousel for a moment where after the cam fills a particular perimeter notch minimizing any further movement of the carousel for the remainder of the axle revolution. Prior to the carousel gears, the drive axle also has a drive gear for mating with a worm gear, which in turn rotates a rolling shutter. The rolling shutter periodically interrupts the optical gate alternately blocking and allowing light to the carousel for a given length of time depending on its dimensions and angle. The shutter drive axle is also linked to a cam which by means of a lever extends and releases an edge whereon a ridge extending from each image sensor assembly and below each image sensor site is caught: assisting in the complete stop of each assembly per motor drive axle revolution. Image information issues based on a trigger integrated in each sensor assembly activated by the contact of the aforementioned edge meeting the ridge extending from each sensor assembly. The trigger activates circuits on all other sensor assemblies in the system. The trigger is activated by means of the contact of the edge that hold the sensor temporarily in place. The force of the edge contacting the ridge on the facing plane of the sensor assembly compresses springs holding the ridge away from sensor assembly, which at a point in compression engage conductive contacts and thereby completes a circuit whereby an electrical signal is sent to all image sensors not in position for exposure. Each image sensor not in position for exposure, thus being signaled, will begin to readout data for transmission from the carousel. This is accomplished by serializing the data and transmitting the information at distinct points where and at such time the carousel is stopped. The carousel will be stopped briefly when each sensor is exposed. During exposure of a respective sensor plane all other sensors simultaneously transmit from the carousel to a receiving plate fitted with PIN type photodiodes at points aligned with Vertical Cavity Surface-Emitting Lasers (VCSELs) fitted into the support structure of each image sensor assembly comprising the electronic imaging carousel. Depending on the density of the sensors fitted to the carousel, more than one VCSEL-PIN pair may be employed to accomplish the desired rate of data transmission.

The respective data inputs received from the carousel are multiplexed based on the carousel's position such that transmitted data is consolidated to a single portion of data resembling the data obtained by a respective image sensor plane, despite the data having been transmitting at a plurality of locations between such times as the carousel is rotating. Optical transmission, while requiring more accuracy in mechanical design, offers transmission that is nearly free of electrical disturbance providing a more desirable signal to noise ratio and therefore is a more reliable and desirable data acquisition for this arrangement.

Finally the data is made available through issuing means to computer or other dedicated hardware whereby the respective image data may be stored, altered, or multiplexed as desired.

What is claimed is:

1. A motion picture camera apparatus or imaging device comprising
imaging means where optical information is converted to electrical information hereafter such means being described as an image sensor or image sensor array.
a plurality of electronic image sensors or sensor arrays arranged for individual optical presentation at the focal point of an optical assembly wherein the system achieves discrete and separate exposure of each image sensor or sensor arrays within the system by physically translating the sensor's or sensor arrays' position and orientation relative to the aforementioned optical assembly by rotation about an axis where both partial and complete revolutions of the assembly is employed. It is immaterial whether the rotation is medial, longitudinal, or transverse. It is immaterial whether the rotation is constant, variable or oscillating.
motor means to rotate the arrangement of image sensors or image sensor arrays about a central axis. It is immaterial whether the motor is constant or variable rate
means to transmit or move information collected by the electronic image sensors or arrays to a storage device or devices, or a circuit, or other issuing device that may be used for subsequent processing of image information. The means of storage is immaterial. The means of issuing the image information is immaterial
a mechanical shutter for selectively exposing an image sensor or sensor array to the focal point of the optical assembly. It is immaterial whether the shutter is fixed or variable

2. A device as set forth in claim 1 used in conjunction with a viewfinder. It is immaterial whether the viewfinder is optical or electronic.
